(19) United States
(12) Patent Application Publication
(10) Pub. No.: US 2005/0225975 A1
(43) Pub. Date: Oct. 13, 2005

(54) Area lighting device

(76) Inventors: Koji Takamura, Osaka (JP); Tatsunobu Kitagawa, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/819,293

(22) Filed: Apr. 7, 2004

(51) Int. Cl. F21V 11/06

(52) U.S. Cl. 362/224; 362/255; 362/240

(57) ABSTRACT

An area lighting device has straight fluorescent lamps (3) arranged side by side at regular intervals, a signboard panel (4) adjacent to front curved faces of the lamps, and a flux regulating cover (5) detachably attached to a frontal curved surface of each lamp. The cover is a split half of a heat-resistant elastic cylinder. A reflective plate (8) in rear of each lamp (3) has a pair of longitudinal crests (9) adjacent to the back face of each lamp so that these crests prevent light beams from scattering sideways from the rear middle region of the lamp, thus reflecting them forwards.

### FIELD OF THE INVENTION

The present invention relates to an area lighting device adapted for use in the multi-tubular lamp signboards, billboards or the like, wherein fluorescent straight lamps are arranged in parallel at regular intervals.

### PRIOR ART

Some proposals have been made in order that the area lighting devices would not produce any lamp images (that is, faded but brighter stripes) in the lighted signboard panel. In one of such proposals, a luminous flux equalizer is disposed in front of the fluorescent lamps and between same and the lighted panel (see the Utility Model Publication No. 63-6767 or No. 2-39281). In another proposal, a reflective plate is fixed in rear of the fluorescent lamps (see the said Publication No. 2-39281 or Utility Model Laying-Open Gazette No. 5-79587).

Such a flux equalizer was intended to prevent any lamp images from occurring even if the fluorescent lamps would be disposed very close to the inner surface of a lighted signboard panel. As disclosed in the gazettes 63-6767 and No. 2-39281, a kind of ‘gobo’ film (viz., a flat shading film) has been suspended with springs between the fluorescent lamps and the surface of lighted panel. When any of those fluorescent lamps had to be replaced with new ones, the gobo film should be removed at first, increasing labor consumption. Electrostatic charges appearing in the front and back sides of such a gobo film have attracted dusts thereto. The dust thus sticking not only to said film but also to the surfaces of those lamps and lighted panel have usually caused intricate cleaning works.

In another flux equalizer also known in the art, a gobo film has been directly adhered to the surfaces of lamps. Such a gobo film had to be thrown away together with the lamps being replaced with new ones, thereby raising maintenance cost.

### SUMMARY OF THE INVENTION

An object of the present invention made in view of these drawbacks is therefore to provide a novel area lighting device convenient to maintenance owing to its flux equalizer that is easy and ready to attach and detach when any of fluorescent lamps have to be replaced with new ones. Such an area lighting device should preferably be adapted for combination with a proper reflective plate. Anyway, the area lighting device of the invention has to provide a uniform lighting effect without fear of producing any lamp image, so that an overall illuminance or lightness increases while significantly economizing electric power.

In order to achieve this object, an area lighting device of the invention comprises a plurality of straight fluorescent lamps arranged side by side at regular intervals and a lighted signboard panel disposed adjacent to front curved faces of the lamps, and characteristically, further comprises a flux regulating cover detachably attached to the frontal curved surface of each lamp. The body of each flux regulating cover may generally be a split half of a heat-resistant elastic cylinder. The bodies of flux regulating covers may be formed of a transparent polycarbonate resin, and have each a pattern of dashed dots directly printed thereon with black ink. Such a regulating cover has a middle longitudinal region facing the frontal and middle longitudinal zone of each front curved face of the lamp, such that a shading effect of the regulating cover shows a peak at said middle region and gradually decreases towards longitudinal side edges of this cover. Alternatively, instead of direct printing, a discrete shading film having such a pattern of dashed dots printed with a black ink may be adhered to the bodies of flux regulating covers formed of a transparent polycarbonate resin.

The area lighting device of the invention may further comprise a reflective plate disposed in rear of each fluorescent lamp. The reflective plate may have formed therein a pair of longitudinal crests to be disposed adjacent to two parallel linear zones of the back face of each lamp. These crests will prevent luminance fluxes from scattering sideways transversely of the lamp away from the rear middle region of the lamp, thus reflecting them forwards.

### BRIEF DESCRIPTION OF THE DRAWINGS

FIG. 1 is a perspective view of an area lighting device of the present invention, wherein its flux regulating cover is going to be attached to or has been removed from a fluorescent lamp;

FIG. 2 is a similar perspective view of the device, but its flux regulating cover having been attached to the lamp;

FIG. 3 is an enlarged cross section taken transversely of the lamp as shown in FIG. 2; and

FIG. 4 is a vertical cross section of the present device shown in its entirety.

### THE PREFERRED EMBODIMENTS

Now an embodiment of the present invention will be described referring to the accompanying drawings.

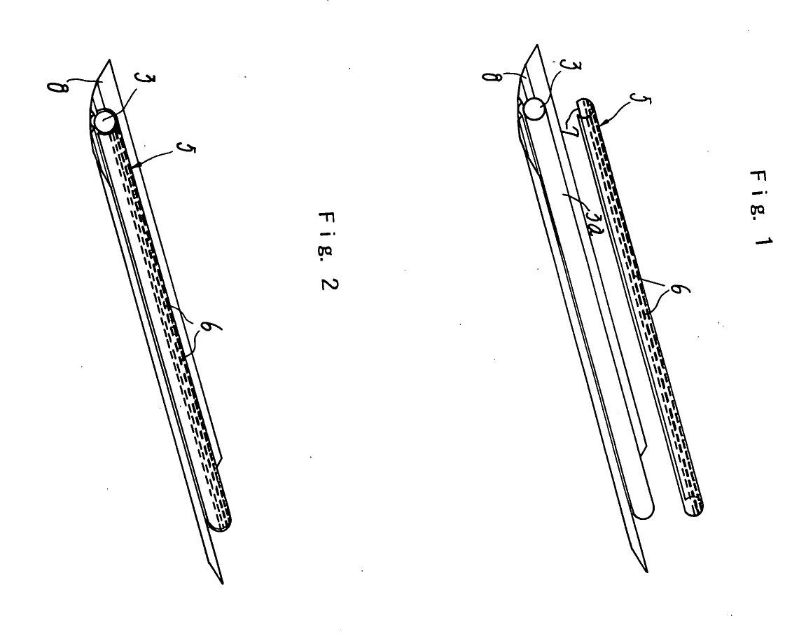

FIGS. 1 to 3 show a principal part of an area lighting device 1 (see FIG. 4) of the invention. A flux regulating cover 5 and a reflective plate 8 are positioned as seen therein relative to each of fluorescent lamps 3. As will be seen in FIG. 4, the device 1 is embodied as a multi-tubular lamp sign-board. A body case 2 of this signboard is a thin parallelepiped box for accommodation of a plurality of the fluorescent lamps 3 arranged side by side at regular intervals. The flux (viz., beams) of light emitted from each lamp 3 will be radiated through a lighted signboard panel 4. The panel 4 is formed of an acrylic resin sheet that is opalescent to diffuse the flux from each lamp.

The flux regulating cover 5 is made of a transparent polycarbonate sheet highly elastic and resistant to heat. This cover is generally a split half of a cylinder such as to be of a radius of curvature fitting on the peripheral surface of each fluorescent lamp 3. A black ink is printed on the flux regulating cover 5 to form thereon a pattern of dashed dots. By forcing this cover to elastically deform itself, it will detachably snap on the frontal and longitudinal face of said lamp. Density of the black lines 6 of said dots is made highest in the cover's middle longitudinal region facing the frontal and middle longitudinal zone of each front curved face of the lamp 3. Thus, the shading effect of the regulating cover 5 shows a peak at said middle region. In contrast, arrangement of the black lines 6 gradually becomes coarser towards the lateral edges of the cover, decreasing is shading effect. In use, such a flux regulating semi-cylindrical cover will be pressed at its longitudinal mouth 7 to the lamp's front face 3a so as to be elastically snapped onto the lamp 3. By easily and simply pulling the cover, it can be removed readily from the lamp. The pattern of lines of dashed dots need not necessarily be printed directly on the polycarbonate cover 5, but such a black ink pattern may alternatively be printed on a shading film before it is adhered to a blank body of the semi-cylindrical cover.

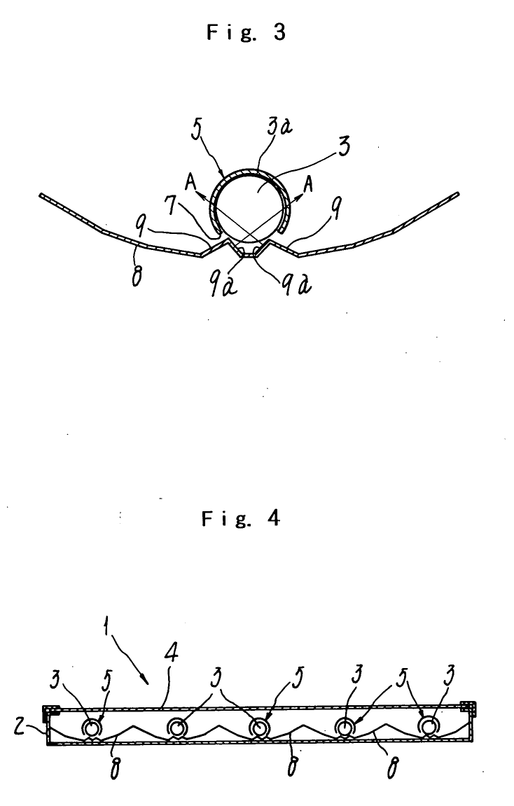

A reflective plate 8 is formed by bending a metal sheet that has a specular surface like a mirror. It may be disposed behind the fluorescent lamp 3 as is usual in the prior art. However, this plate 8 employed in the invention has characteristically a pair of longitudinal crests 9 and 9. These crests will be disposed adjacent to two parallel linear zones of the back face of each lamp 3. These crests will prevent luminance fluxes from scattering sideways transversely of the lamp, thus reflecting them forwards. In detail, as indicated by the arrows ‘A’ and ‘A’ in FIG. 3, the inner face of each crest 9 reflects forwards the light beams which the lamp emits backwards. Such reflected flux will be transmitted through the cover's zones that are less fading and located adjacent to the lateral edges of said cover 5. The flux reflected in this way will add to the ray incident on the signboard panel 4. The overall ‘lux’ value of this panel is thus noticeably increased by virtue of such a reflector 8, compensating the cover's 5 tendency to lower the effective luminous flux density of said panel.

In the area lighting device 1 as described above, forward rays from the respective fluorescent lamps 3 are partially intercepted by the flux regulating cover 5. Thanks to this feature, these lamps can be disposed closer to the signboard panel 4, without giving rise to the problem of lamp images. Further, since the reflector 8 contributes to increase the flux density of said panel, the number of necessary lamps 3 can be reduced so as to save consumption of electric power. The area lighting device of the invention is particularly adapted for use with a thinner type of signboards.

In summary, one of the species of the present invention as defined in the accompanying claims 1 to 3 is effective to decrease a distance between fluorescent lamps and a signboard panel, not producing any lamp images but rendering thinner the area lighting device. The flux regulating covers are ready to attach to or detach from the lamps when any of them have been or are just being replaced with new ones. Such reused covers are beneficial to make easier the handling and maintenance of the present device of area light.

The other species of the invention as defined in claims 4 and 5 employs a reflective plate that affords another advantage that uniform lightness will be realized over full area of the signboard panel, also avoiding lamp images. The reflector increases the flux density of said panel, so that the number of lamps can be reduced to save electric power, thus rendering the area lighting device adapted for use in thinner types of signboards.

1. An area lighting device comprising:
a plurality of straight fluorescent lamps arranged side by side at regular intervals,
a lighted signboard panel disposed adjacent to front curved faces of the lamps, and
a flux regulating cover detachably attached to a frontal curved surface of each lamp,
wherein a body of each flux regulating cover generally is a split half of a heat-resistant elastic cylinder.

2. An area lighting device as defined in claim 1, wherein the bodies of the flux regulating covers are farmed of a transparent polycarbonate resin, and have each a pattern of dashed dots directly printed thereon with a black ink, and wherein such a regulating cover has a middle longitudinal region facing the frontal and middle longitudinal zone of each front curved face of the lamp, so that a shading effect of the regulating cover shows a peak at said middle region and gradually decreases towards longitudinal side edges of this cover.

3. An area lighting device as defined in claim 1, wherein the bodies of the flux regulating covers have each a discrete shading film that has a pattern of dashed dots printed with a black ink and is adhered to each body of the flux regulating cover formed of a transparent polycarbonate resin, and wherein such a regulating cover has a middle longitudinal region facing the frontal and middle longitudinal zone of each front curved face of the lamp, so that a shading effect of the regulating cover shows a peak at said middle region and gradually decreases towards longitudinal side edges of this cover.

4. An area lighting device as defined in claim 1, further comprising a reflective plate disposed in rear of each fluorescent lamp.

5. An area lighting device as defined in claim 4, wherein the reflective plate has formed therein a pair of longitudinal crests to be disposed adjacent to two parallel linear zones of the back face of each lamp so that these crests prevent luminance fluxes from scattering sideways transversely of the lamp away from the rear middle and longitudinal region thereof, thus reflecting them forwards.
